(19) United States
(12) Patent Application Publication
(10) Pub. No.: US 2010/0032318 A1
(43) Pub. Date: Feb. 11, 2010

(54) SYSTEM AND METHOD FOR AMMONIA AND HEAVY HYDROCARBON (HC) SENSING

(76) Inventors: Da Yu Wang, Troy, MI (US); David Racine, Grand Blanc, MI (US); David D. Cabush, Howell, MI (US)

Correspondence Address: Delphi Technologies, Inc., M/C 480-410-202, PO BOX 5052, Troy, MI, 48007, US

(21) Appl. No.: 12/187,870

(22) Filed: Aug. 7, 2008

(51) Int. Cl. G01N 27/26

(52) U.S. Cl. 205/781; 204/431

(57) ABSTRACT

A gas measurement system includes a sensor element and an associated electronic control unit (ECU) or the like connected thereto for receiving sensor element emf outputs. The ECU is configured to provide output signals or parameters indicative of ammonia and heavy HC gas concentrations. The sensor element has an NH₃ sensor electrode output and a NOₓ sensor electrode output. The information conveyed by the NOₓ sensor electrode output may be selectively used by the ECU, in accord with so-called emf selection rules, to correct for a cross-interference effect that NO₂ has on the NH₃ electrode. Heavy HC gas concentrations may cause electrochemical activity on the NH₃ electrode, and can be misinterpreted. A further emf selection rule is configured to detect the presence of heavy HC gas and is used by the ECU to suppress an output signal or parameter indicative of an ammonia gas concentration.

### INCORPORATION BY REFERENCE

This application incorporates by reference the disclosure of the following in their entireties: U.S. application Ser. No. 11/538,240 filed on Oct. 3, 2006 entitled “MULTICELL AMMONIA SENSOR AND METHOD OF USE THEREOF” (attorney docket no. DP-313576); U.S. application Ser. No. 11/451,939 filed on Jun. 13, 2006 entitled “SYSTEM AND METHOD FOR MONITORING OPERATION OF AN EXHAUST GAS TREATMENT SYSTEM” (attorney docket no. DP-314445); U.S. Provisional Application No. 60/725,054 filed Oct. 7, 2005; U.S. Provisional Application No. 60/725,055 filed Oct. 7, 2005; U.S. Provisional Application No. 60/734,087 filed Nov. 7, 2005; and U.S. Pat. No. 7,074,319 issued Jul. 11, 2006 entitled “AMMONIA GAS SENSORS.”

### BACKGROUND OF THE INVENTION

Exhaust gas generated by combustion of fossil fuels in furnaces, ovens, and engines contain, for example, nitrogen oxides (NOₓ), unburned hydrocarbons (HC), and carbon monoxide (CO). Vehicles, e.g., diesel vehicles, utilize various pollution-control after treatment devices (such as a NOₓ absorber(s) and/or selective catalytic reduction (SCR) catalyst(s)), to reduce NOₓ. For diesel vehicles using SCR catalysts, NOₓ reduction can be accomplished by using ammonia gas (NH₃) or urea water solution. In order for SCR catalysts to work efficiently and to avoid pollution breakthrough, an effective feedback control loop is needed. To develop such technology, the control system needs reliable commercial ammonia sensors.

One group of ammonia sensor designs operate based on the Nernst Principle, where the sensor converts chemical energy from NH₃ into electromotive force (emf). The sensor can measure this electromotive force to determine the partial pressure of NH₃ in a sample gas. However, these sensors also convert the chemical energy from NOₓ gas into electromotive force. Therefore, when determining partial pressure based on electromotive force, the sensor is not able to effectively distinguish between NH₃ and NOₓ.

Another group of ammonia sensor designs use a dual-cell configuration where one cell is configured to sense ammonia and another cell is configured to sense NOₓ (e.g., NO₂). The output of the NOₓ cell is used to correct cross-interference effects that NO₂ has on the ammonia sensing cell. In addition, an electronic control unit (ECU) or the like that is connected to the dual-cell sensor must implement so-called emf selection rules. For example, under certain conditions, the emf from the NH₃ cell may be more accurate than the emf across the NH₃ and NOₓ cells.

However, there are complications in using the dual-cell sensor design. For example, during diesel engine operation, there are at times heavy hydrocarbon (HC) slips. This situation may occur, for example, when the engine goes through rapid acceleration, where a large quantity of fuel is consumed in a short period of time while the engine-out oxidation catalytic converter has not yet warmed up to its effective operating temperature (e.g., a cold start situation). The chemistry of ammonia and heavy HC gas species is similar enough that the heavy HC gas causes an electrochemical reaction on the surface of known ammonia sensing electrode materials (e.g., metal vanade oxide materials—BiVO₄). In other words, the ammonia sensing electrode will have a response to the presence of the heavy HC gas as though it were being exposed to ammonia. Under these circumstances, there is a need to detect the slips of heavy HC so as to avoid interpreting the heavy HC slips as ammonia slips.

There is therefore a need for a gas measurement system that minimizes or eliminates one or more of the problems set forth above.

### SUMMARY OF THE INVENTION

One advantage of the invention is that it enables an ECU or the like to avoid mis-interpreting heavy HC-induced sensor readings for high concentrations of ammonia. The invention also has the advantage of providing a method for determining the concentration of heavy HC gas in a measurement or test gas (e.g., a diesel engine exhaust gas).

A method is provided according to the invention for operating a gas measurement system having a sensor element and an associated electronic control unit (ECU) or the like. The sensor element is configured to output a first signal originating from an ammonia sensing electrode which has a sensitivity to heavy hydrocarbons (HC), in addition to a sensitivity to ammonia. The sensor element is further configured to output a second signal originating from a NOₓ sensing electrode. The method includes the step of suppressing a third signal, indicative of an ammonia concentration in the measurement gas, when a difference between the second signal and the first signal is greater than or equal to a first threshold (i.e., which indicates the presence of heavy HC).

A system is also presented.

### BRIEF DESCRIPTION OF THE DRAWINGS

The present invention will now be described by way of example, with reference to the accompanying drawings:

FIG. 1 is a simplified block diagram view of a gas measurement system including an ammonia sensor element connected to an electronic control unit (ECU) programmed with a new emf selection rule according to the invention.

FIG. 2 is a flowchart showing, in greater detail, the processing involved in carrying out the emf selection rules according to the invention.

FIG. 3 is a timing diagram showing HC concentration levels versus engine speed for an exemplary heavy HC slip.

FIG. 4 is a timing diagram showing the effect of the heavy HC slip of FIG. 3 on the sensor element's emf outputs.

FIG. 5 is a timing diagram showing the ammonia concentration as determined using conventional emf selection rules.

FIG. 6 is a timing diagram showing the ammonia concentration as determined using the inventive emf selection rules.

FIG. 7 is an exploded view of an exemplary planar sensor element.

FIG. 8 is a graphical representation of the voltage across an NH₃ cell, the voltage across a NOₓ cell, and the voltage across an NH₃—NOₓ cell, at selected partial pressures of NOₓ and of NH₃ in a sample gas.

### DETAILED DESCRIPTION OF THE PREFERRED EMBODIMENT

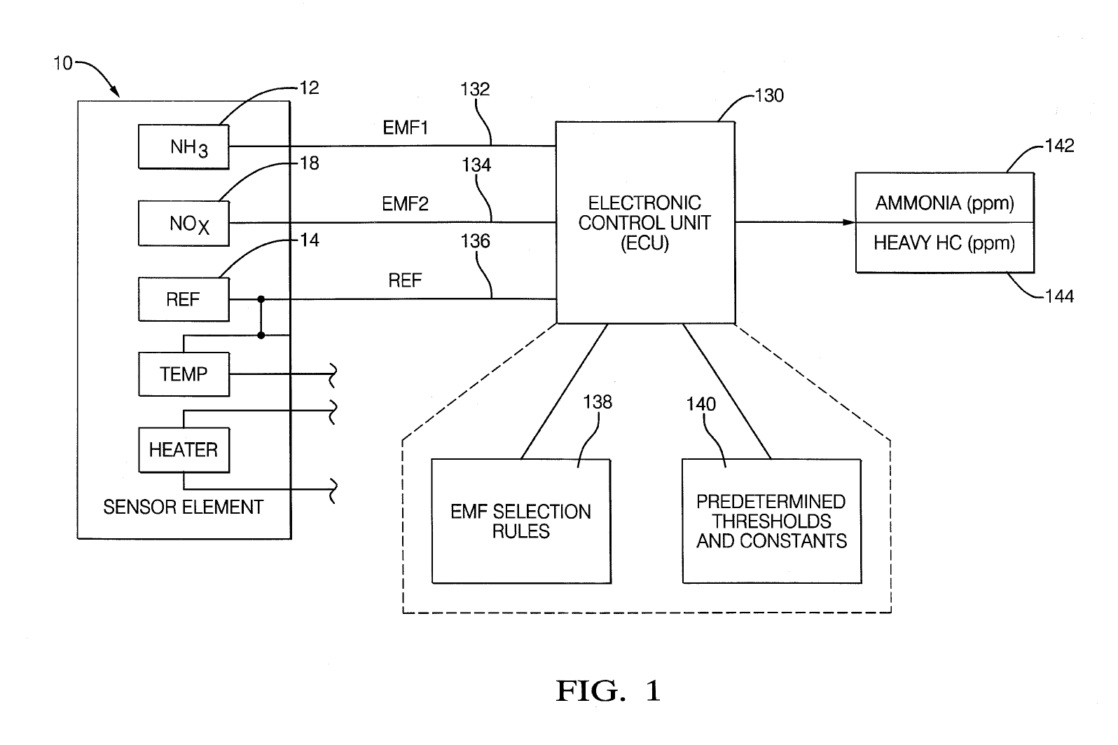

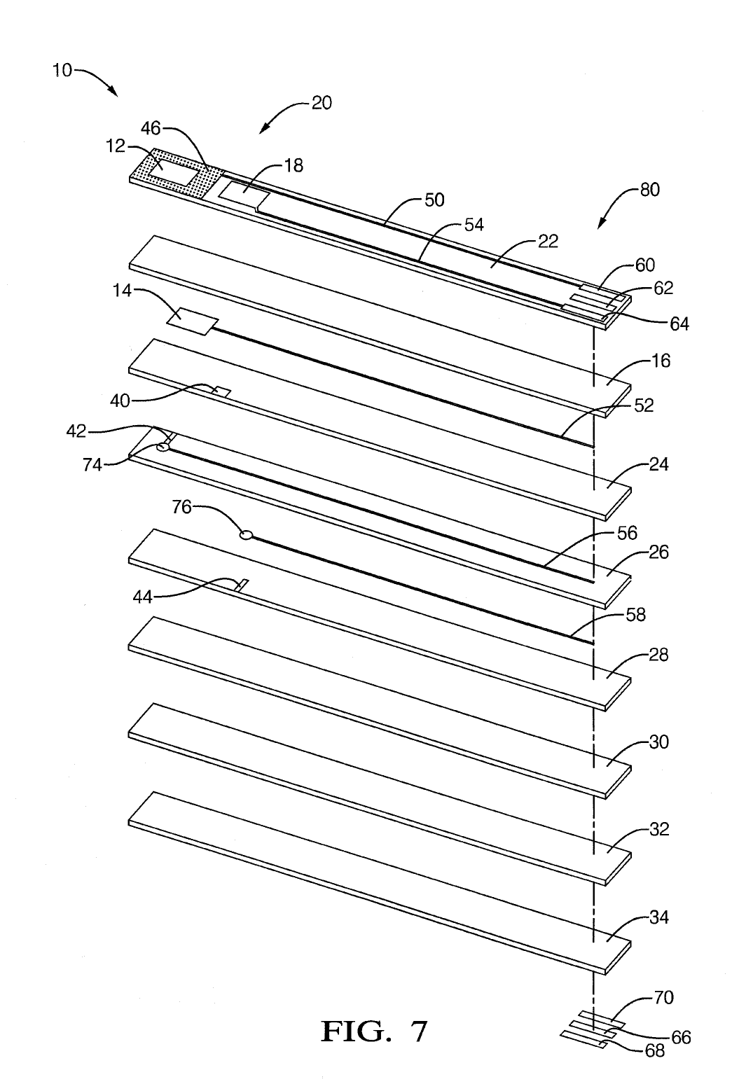

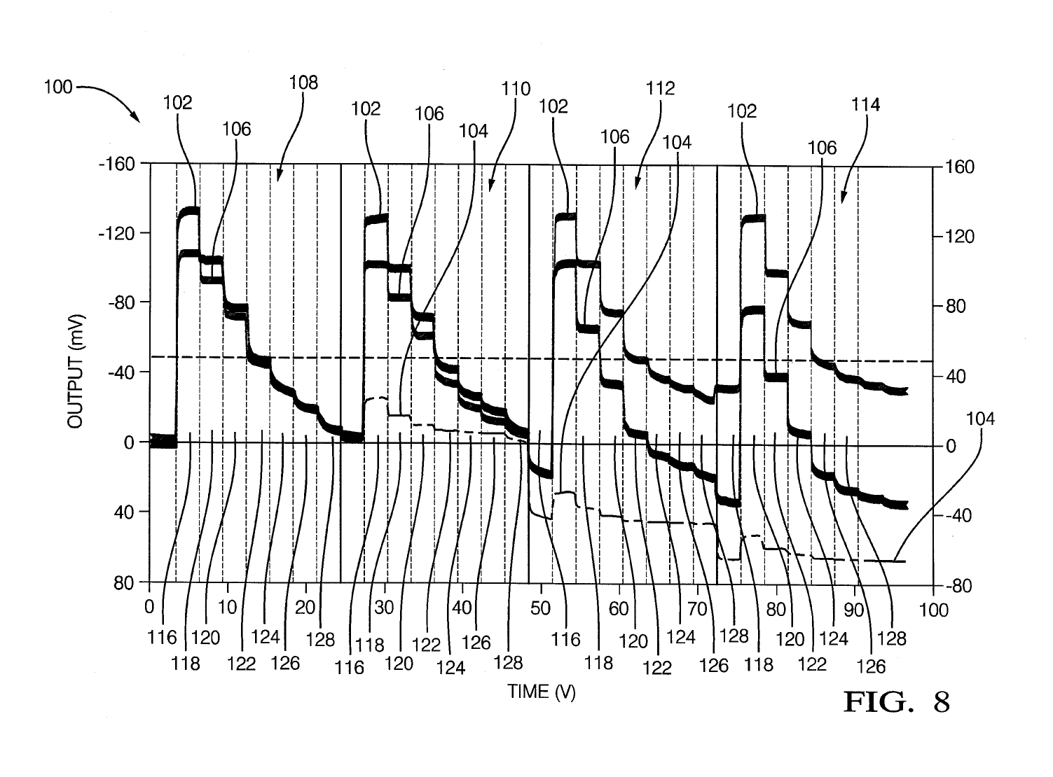

Referring now to the drawings wherein like reference numerals are used to identify identical components in the various views, FIG. 1 is a block diagram of a gas measurement system including an ammonia sensing element 10 and an associated electronic control unit (ECU) 130. In an automotive application, the ECU may be an engine control module (ECM). The sensing element 10 is shown in simplified block form and may be of a multi-cell construction as described in the Background (and as will be described in greater detail below in connection with FIGS. 7-8). Ammonia sensing is achieved in the sensing element 10, generally speaking, by using non-equilibrium electrochemical sensing principles. However, the ammonia sensing electrode 12 is vulnerable to and may incur a cross interference sensing effect from the presence of NO₂ in the measurement gas. To correct for this unwanted effect, the NO₂ concentration needs to be known. For this purpose, a second, NOₓ sensing cell is provided. The information obtained from the NOₓ sensing cell is selectively used (under certain conditions) to correct for the NO₂ cross interference effect. The ammonia sensing cell is formed by an ammonia (NH₃) sensing electrode 12, an electrolyte (best shown in FIG. 7—electrolyte 16) and a reference electrode 14. The NOₓ sensing cell formed by a NOₓ sensing electrode 18, an electrolyte (best shown in FIG. 7—electrolyte 16) and the reference electrode 14. Also shown are temperature probe (sensor) and its related leads as well as an electrical heating element and its related leads. One of the temperature connections may be shared with the reference electrode. The sensor element 10 is configured to output (1) a first electromotive force (emf1) between the NH₃ sensing electrode 12 (lead 132) and the reference electrode 14 (lead 136); and (2) a second electromotive force (emf2) between the NOₓ sensing electrode 18 (lead 134) and the reference electrode 14 (lead 136).

The ECU 130 is configured to include a set of EMF selection rules 138 to be evaluated in conjunction with a variety of associated predetermined thresholds and constants 140. Through use of these selection rules, the ECU 130 is configured (more below) to generate a signal or other parameter 142 indicative of the ammonia concentration in the measurement gas. In addition, the ECU 130 may be further configured (more below) to generate a signal or other parameter 144 indicative of a heavy hydrocarbon (HC) gas concentration.

More specifically, the set of selection rules (viz. implemented in software) is included in the gas measurement system for use in determining when to use (and when not to use) the NOₓ cell output (information) to correct for the cross-interference that NO₂ has on the NH₃ electrode. While this is described in greater detail below in connection with FIGS. 7-8, in sum, one approach is (i) to use a selection function to generate a corrected ammonia sensing emf, as in equation (1) below, and then, (ii) to use the corrected emf to calculate an ammonia concentration (equation (2)). Equation 1 is shown below.

Corrected emf=IF(emf2>=K, emf1, emf1−emf2) (1)

where K is a threshold (preferably a constant) and where emf1 is the first electromotive force described above and emf2 is the second electromotive force described above.

The form of the IF (selection) function statement is: IF(logical_test, value_if_true, value_if_false). In the presence of NH₃, both the NH₃ and the NOₓ sensing cells will produce a respective emf. However, in the presence of low NO₂ concentrations, the NOₓ sensing cell will produce a positive (or zero) emf, while at high NO₂ concentrations, the NOₓ sensing cell will produce a negative emf (with the reference electrode 14 set at positive polarity). Thus, at higher concentrations, the NO₂ reacts at both the NH₃ and NOₓ sensing electrodes. Accordingly, at higher NO₂ concentrations, the reactions due to NO₂ are approximately equal, resulting in a zero overall change (one with respect to the other). Therefore, for lower NO₂ concentrations, the NH₃ sensing cell (emf1) is more accurate while at higher NO₂ concentrations, the NH₃—NOₓ sensing cell (emf1−emf2) is more accurate. Equation (1) above reflects this logic.

The ECU 130 is configured to then generate an ammonia gas concentration (i.e., ppm) using equation (2), which uses the corrected emf determined above.

Ammonia (ppm)=A+B*EXP(C*corrected emf) (2)

where A, B and C are constants.

As described in the Background, the above methodology for determining ammonia gas concentration may, however, be impaired if there is a heavy HC gas concentration in the engine exhaust. This is due to the heavy HC and ammonia gases causing similar electrochemical reactions on the NH₃ electrode 12. To avoid having the ECU 130 misinterpret the emf signals and report a high concentration of NH₃, a new selection rule in equation (3) is provided.

Corrected emf=IF(emf2−emf1>=D, 0, IF(emf2>=K, emf1, emf1−emf2)) (3)

Where D is a threshold (preferably a constant), which may be determined empirically, i.e., from data generated by testing sensors at engine test cells.

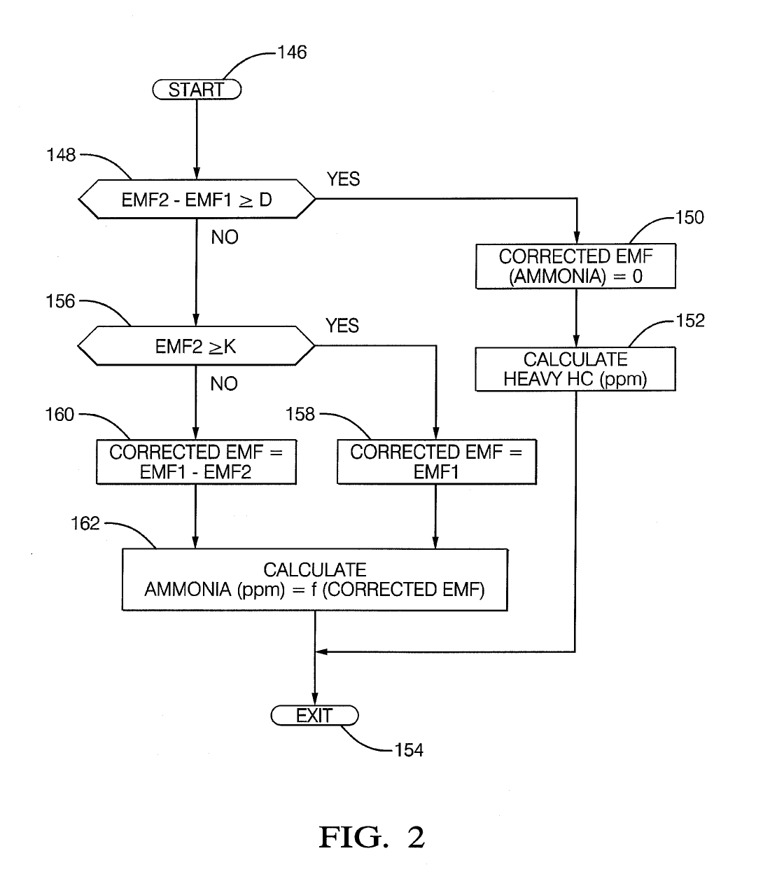

FIG. 2 is a flowchart showing the methodology of the invention for identifying when heavy HC gas may impair the accuracy of calculated ammonia gas concentration and to take appropriate action instead. The method begins in step 146 and proceeds to step 148.

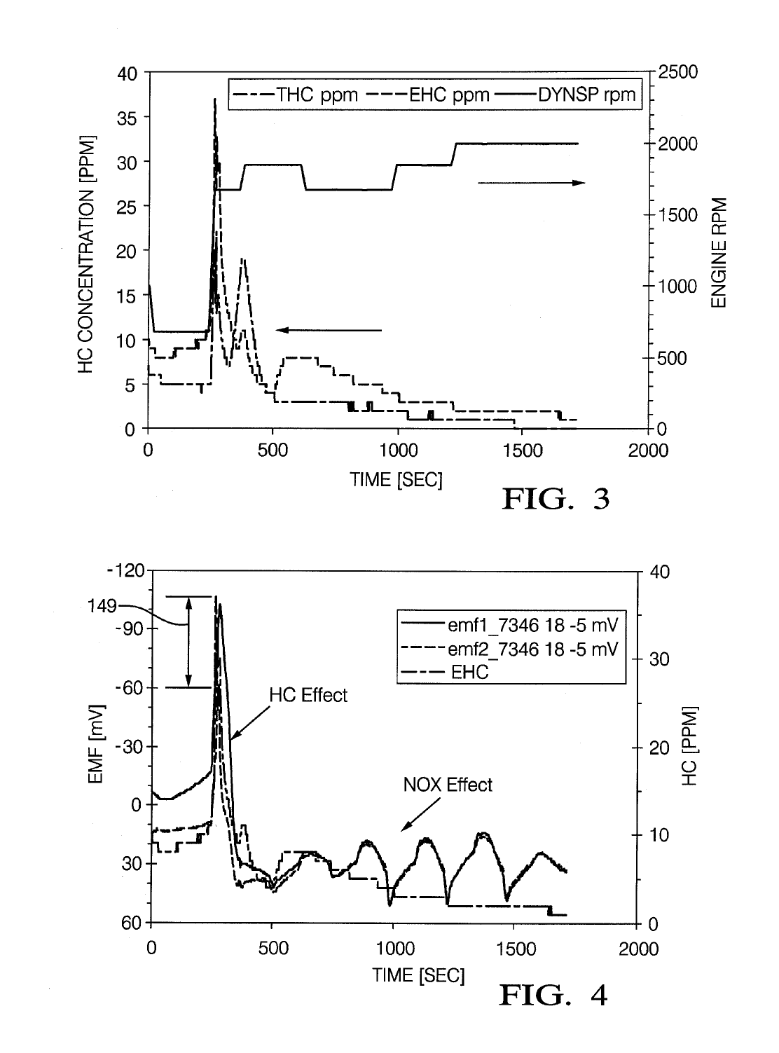

In step 148, the ECU 130 determines whether the difference between the NOₓ and the NH₃ sensing electrode's emf's (i.e., emf2−emf1) is greater than or equal to a first threshold (“D”). The first threshold (“D”) is selected so that when the differential exceeds the threshold, the presence of heavy HC can be assumed. FIGS. 3 and 4 will illustrate an example of how this can be manifested.

FIG. 3, in this regard, is a timing diagram showing diesel engine speed and HC concentration. FIG. 3 shows a scenario where a heavy HC concentration can occur that can be misinterpreted by the ECU as indicating the presence of ammonia. FIG. 3 shows the situation described in the Background where the engine undergoes a sharp increase in speed (i.e., between time 200-300 seconds), transitioning from about 700 RPM to about 1700 RPM. FIG. 3 also shows the corresponding sharp increase in heavy hydrocarbon (HC) gas.

FIG. 4 is a timing diagram showing both HC concentration as well as the sensor element's electrode outputs (i.e., emf1 [NH₃] and emf2 [NOₓ]). FIG. 4 is scaled and is time registered with traces in FIG. 3. FIG. 4 shows that the presence of heavy HC gas can be detected based on the emf differential emf2−emf1. An example of this differential for a particular point in time is identified by reference numeral 149. If the differential exceeds D, then heavy HC gas is assumed. Step 148 essentially begins evaluating the selection rules embodied in equation (3). If the answer is “YES”, then the method proceeds to step 150.

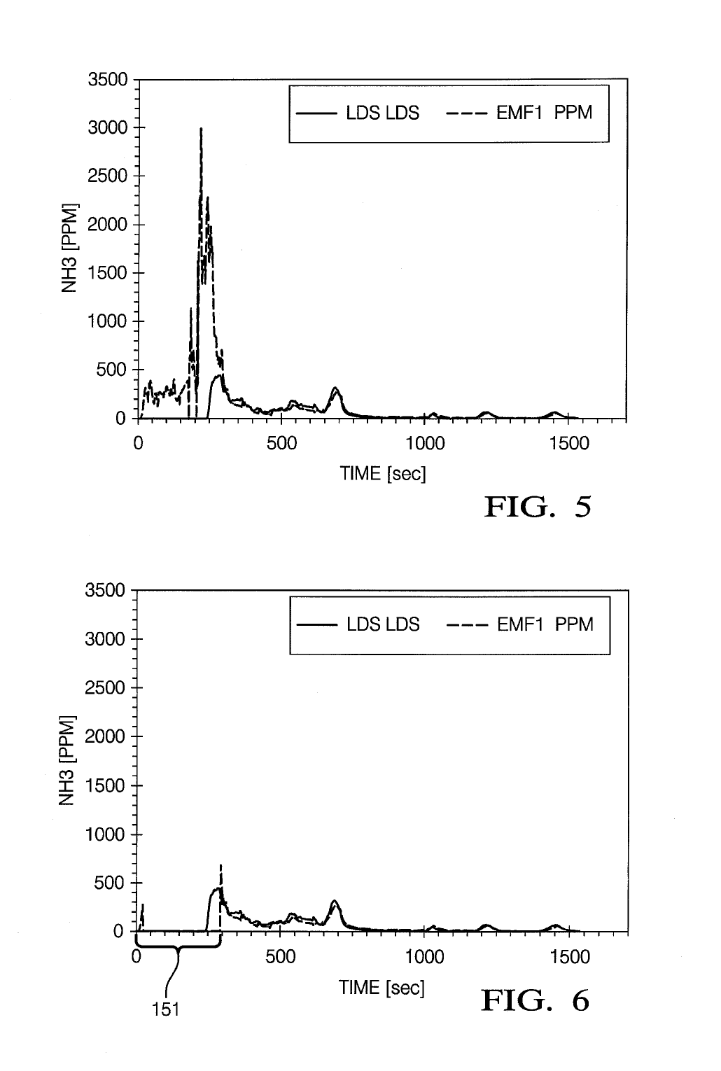

Referring back to FIG. 2, in step 150, since heavy HC gas has been detected, the ECU 130 sets the corrected emf for ammonia concentration calculation purposes to zero. FIGS. 5 and 6 will illustrate the import of this action.

FIG. 5 is a timing diagram showing ammonia concentration as measured by a reference instrument (“LDS”) as well as calculated from the sensor emf outputs using conventional emf selection rules. FIG. 5 is also on the same time scale as FIGS. 3-4. As shown in FIG. 5, using the conventional emf selection rules, the high heavy HC gas concentration is misinterpreted as a high ammonia concentration (i.e., the peak is approximately 3000 ppm). This misinterpretation is confirmed by comparison with the reference trace, which indicates an actual, maximum ammonia concentration to be no greater than about 500 ppm.

FIG. 6 is a timing diagram showing ammonia concentration as measured by the reference instrument (“LDS”) as well as calculated from the sensor emf outputs using the new emf selection rules. FIG. 6 is also on the same time scale as FIGS. 3-5. As shown in FIG. 6, using the new emf selection rules, the ammonia concentration is suppressed or inhibited during the time interval designated 151, or in other words while (emf2−emf1)>=D. This is confirmed by comparison with the reference trace.

Referring back to FIG. 2, the ammonia concentration (ppm) may still be calculated as set forth in equation (2) above or may be suppressed entirely. The method then proceeds to step 152.

In step 152, the ECU 130 may be configured to calculate (optionally) a heavy HC gas concentration (ppm). The invention contemplates two calculation approaches, based on whether the heavy HC concentration is low or high. For example, which equations will be chosen will be determined by the types of engine used. For engines that are of an advanced type and produce small amounts of HC, Equation 4 will be used. For those engines that generate a relatively large amount of HC, equation 5 will be used. In other words, it depends on the type of engine in which the sensors will be used. For example, a simple approach, when the heavy HC concentration is low, may involve evaluation of equation (4):

Heavy HC (ppm)=IF(emf2−emf1>=D, emf1*G, 0) (4)

Where G is a constant. Note that the logical test in equation (4) is the same as in equation (3) (i.e., it is the test to determine the existence of heavy HC gas in the measurement/test gas). Also note that the heavy HC concentration simply involves scaling the emf1 by the constant G.

Alternatively, where the heavy HC concentration is high, equation (5) may be used.

Heavy HC (ppm)=IF(emf2−emf1>=D, G+H*EXP(J*emf1)) (5)

Where G, H and J are constants. Note, the form of this equation is the same as for the ammonia concentration calculations.

In either case, the method then proceeds away from step 152 and exits at step 154.

Alternatively, if the answer in step 148 is “NO”, then the method proceeds to step 156. In step 156, the previous emf selection rules are evaluated as stated in equation (1). If the answer in step 156 is “YES”, then the NO₂ concentration is relatively low, and the method proceeds to step 158, where the corrected emf is given the emf value of the NH₃ sensing cell (i.e., emf1). Otherwise, if the answer in step 156 is “NO” then the method proceeds to step 160, where the corrected emf is given the emf value of the NH₃—NOₓ sensing cell (i.e., emf1−emf2). In either event, the method proceeds to step 162.

In step 162, the ECU 130 is configured to calculate the ammonia gas concentration (ppm) as a function of the now-determined corrected emf. Equation (2) may be used.

With continued reference to FIG. 1, and as to the general structure, the ECU 130 to perform its functions includes at least one microprocessor or other processing unit, associated memory devices such as read only memory (ROM) and random access memory (RAM), a timing clock, input devices for monitoring input from external analog and digital devices and controlling output devices. In general, in an automotive vehicle embodiment, the ECU 130 may be operable to monitor engine operating conditions and other inputs (e.g., operator inputs) using the plurality of sensors and input mechanisms, and control engine operations with the plurality of output systems and actuators, using pre-established algorithms and calibrations that integrate information from monitored conditions and inputs. The software algorithms and calibrations which are executed in the ECU 130 may generally comprise conventional strategies known to those of ordinary skill in the art. Overall, in response to the various inputs, the ECU 130 develops the necessary outputs to control the throttle valve position, fuel, spark, and other aspects, all as known in the art.

While the present invention may be used to provide improved heavy HC gas detection with a wide variety of ammonia sensors of the type having both ammonia sensing and NOₓ sensing electrodes, one exemplary ammonia sensor element, shown and described in connection with FIGS. 7-8 will now be described so as to ensure that one of ordinary skill in the art may easily practice the invention. It bears emphasizing that the following detailed description of a sensor element is not intended to be limiting as to the range and variety of structures that can be used in connection with the heavy HC detection method of the invention.

Referring to FIG. 7, in an exemplary embodiment, a sensor element 10 comprises a NH₃ sensing cell; comprising a NH₃ electrode 12, a reference electrode 14 and an electrolyte 16 (12/16/14), a NOₓ sensing cell, comprising a NOₓ electrode 18, the reference electrode 14 and the electrolyte 16 (18/16/14), and an NH₃—NOₓ sensing cell, comprising the NH₃ and NOₓ electrodes 12, 18 and the electrolyte 16 (12/16/18). The NH₃ sensing cell 12/16/14, the NOₓ sensing cell 18/16/14, and the NOₓ—NH₃ sensing cell 12/16/18 are disposed at a sensing end 20 of the sensor element 10. The sensor comprises insulating layers 22, 24, 28, 30, 32, 34, and active layers, which include layer 26 and the electrolyte layer 16. The active layers can conduct oxygen ions, where the insulating layers can insulate sensor components from electrical and ionic conduction and/or provide structural integrity. In an exemplary embodiment, the electrolyte layer 16 is disposed between insulating layers 22 and 24, and active layer 26 is disposed between insulating layers 24 and 28.

The sensor element 10 can further comprise, a temperature sensing cell (and/or air to fuel ratio sensor) comprising the active layer 26 and electrodes 74 and 76 (74/26/76), a heater (not shown), and/or an electromagnetic force shield (not shown). An inlet 40 can be defined by a first surface of the insulating layer 24, and by a surface of the electrolyte 16, proximate reference electrode 14. An inlet 42 can be defined by a first surface of the active layer 26 and by a second surface of the insulating layer 24. An inlet 44 can be defined by a surface of the layer 28 and a second surface of the active electrolyte layer 26. In addition, the sensor element 10 can comprise a current collector 46, electrical leads 50, 52, 54, 56, 58, contact pads 60, 62, 64, 66, 68, 70, ground plane (not shown), ground plane layers(s) (not shown), and the like.

For placement in a gas stream, sensor element 10 can be disposed within a protective casing (not shown) having holes, slits, and/or apertures, which can optionally act to generally limit the overall exhaust gas flow in physical communication with sensor element 10.

The NH₃ electrode 12 is disposed in physical and ionic communication with the electrolyte 16 and can be disposed in fluid communication with a sample gas (e.g., a gas being monitored or tested for its ammonia concentration). Under the operating conditions of the sensor element 10, the general properties of the NH₃ electrode material include NH₃ sensing capability (e.g., catalyzing NH₃ gas to produce an electromotive force (emf)), electrical conducting capability (conducting electrical current produced by the emf), and gas diffusion capability (providing sufficient open porosity so that gas can diffuse throughout the electrode and to the interface region of the NH₃ electrode 12 and the electrolyte 16). Possible NH₃ electrode materials include first oxide compounds of vanadium (V), tungsten (W), and molybdenum (Mo), as well as combinations comprising at least one of the foregoing, which can be doped with second oxide components, which can increase the electrical conductivity or enhance the NH₃ sensing sensitivity and/or NH₃ sensing selectivity to the first oxide components. Exemplary first components include the ternary vanadate compounds such as bismuth vanadium oxide (BiVO₄), copper vanadium oxide (Cu₂(VO₃)₂), ternary oxides of tungsten, and/or ternary molybdenum (MoO₃), as well as combinations comprising at least one of the foregoing. Exemplary second component metals include oxides such as alkali oxides, alkali earth oxides, transition metal oxides, rare earth oxides, and oxides such as SiO₂, ZnO, SnO, PbO, TiO₂, In₂O₃, Ga₂O₃, Al₂O₃, GeO, and Bi₂O₃, as well as combinations comprising at least one of the foregoing. The NH₃ electrode material can also include traditional oxide electrolyte materials such as zirconia, doped zirconia, ceria, doped ceria, or SiO₂, Al₂O₃ and the like, e.g., to form porosity and increase the contact area between the NH₃ electrode material and the electrolyte. Additives of low soft point glass frit materials can be added to the electrode materials as binders to bind the electrode materials to the surface of the electrolyte. Further examples of NH₃ sensing electrode materials can be found in U.S. patent Ser. No 10/734,018, to Wang et al., now U.S. Pat. No. 7,074,319, and commonly assigned herewith.

The current collector 46 is disposed in physical contact and electrical communication with a periphery of the NH₃ electrode 12 and the electrical lead 50. The current collector 46 is disposed so as to have minimal, and more specifically, no physical contact with the electrolyte 16. Under the operating conditions of the sensor element 10, the general properties of the current collector 46 include (i) electrical conducting capability (ability to collect and conduct current), and (ii) low or no catalytic, electrochemical, and chemical reactivity (e.g., so as not to significantly react with the sample gas). Possible materials for the current collector can include non-reactive gold (Au), platinum (Pt), palladium (Pd), rhodium (Rh), as well as combinations comprising at least one of the foregoing (e.g., gold platinum alloys (Au—Pt), gold palladium alloys (Au—Pd), that have been processed to have the desired chemical reactivity). Other examples include unalloyed Group VIII refractory metals such as iridium (Ir), osmium (Os), ruthenium (Ru), and rhodium (Rh). Current collector 46 can include additives to reduce the material's reactivity with the sample gas. For example, stuffing Pt with alumina (Al₂O₃) and/or with silica (SiO₂) will decrease gas reactivity by eliminating the porosity of the material, decreasing the surface area available for gas reactions, and rendering the Pt non-reactive.

The reference electrode 14 is disposed in physical contact and ionic communication with the electrolyte 16 and can be disposed in fluid communication with the sample gas or reference gas; preferably with the sample gas. Under the operating conditions of sensor element 10, the general properties of the material forming the reference electrode 14 include: equilibrium oxygen catalyzing capability (e.g., catalyzing equilibrium O₂ gas to produce an emf), electrical conducting capability (conducting electrical current produced by the emf), and gas diffusion capability (providing sufficient open porosity so that gas can diffuse throughout the electrode and to the interface region of the electrode 14 and electrolyte 16). Possible electrode materials include platinum (Pt), palladium (Pd), osmium (Os), rhodium (Rh), iridium (Ir), gold (Au), and ruthenium (Ru), as well as combinations comprising at least one of the foregoing materials. The electrode can include metal oxides such as zirconia and/or alumina that can increase the electrode porosity and increase the contact area between the electrode and the electrolyte. In another embodiment, the reference electrode 14 can comprise two separate reference electrodes. In this embodiment, one reference electrode could be disposed in electrical and ionic communication with the NH₃ sensing cell and a different reference electrode could be disposed in electrical and ionic communication with the NOₓ sensing cell.

The NOₓ electrode 18 is disposed in physical contact and ionic communication with the electrolyte 16 and can be disposed in fluid communication with the sample gas. Under the operating conditions of sensor element 10, the general properties of the NOₓ electrode material(s) include, NOₓ sensing capability (e.g., catalyzing NOₓ gas to produce an emf), electrical conducting capability (conducting electrical current produced by the emf), and gas diffusion capability (providing sufficient open porosity so that gas can diffuse throughout the electrode and to the interface region of the electrode and electrolyte). These materials can include oxides of ytterbium, chromium, europium, erbium, zinc, neodymium, iron, magnesium, gadolinium, terbium, chromium, as well as combinations comprising at least one of the foregoing, such as YbCrO₃, LaCrO₃, ErCrO₃, EuCrO₃, SmCrO₃, HoCrO₃, GdCrO₃, NdCrO₃, TbCrO₃, ZnFe₂O₄, MgFe₂O₄, and ZnCr₂O₄, as well as combinations comprising at least one of the foregoing. Further, the NOₓ electrode can comprise dopants that enhance the material(s)' NOₓ sensitivity and selectivity and electrical conductivity at the operating temperature. These dopants can include one or more of the following elements: Ba (barium), Ti (titanium), Ta (tantalum), K (potassium), Ca (calcium), Sr (strontium), V (vanadium), Ag (silver), Cd (cadmium), Pb (lead), W (tungsten), Sn (tin), Sm (samarium), Eu (europium), Er (Erbium), Mn (manganese), Ni (nickel), Zn (zinc), Na (sodium), Zr (zirconium), Nb (niobium), Co (cobalt), Mg (magnesium), Rh (rhodium), Nd (neodymium), Gd (gadolinium), and Ho (holmium), as well as combinations comprising at least one of the foregoing dopants.

Under the operating conditions of the sensor element 10, a general property of the electrolyte 16 is oxygen ion conducting capability. It can be dense for fluid separation (limiting fluid communication of the gases on each side of the electrolyte 16) or porous to allow fluid communication between the two sides of the electrolyte. The electrolyte 16 can comprise any size such as the entire length and width of the sensor element 10 or any portion thereof that provides sufficient ionic communication for the NH₃ cell (12/16/14), for the NOₓ cell (18/16/14), and for the NH₃ —NOₓ cell (12/16/18). Possible electrolyte materials include zirconium oxide (zirconia) and/or cerium oxide (ceria), LaGaO₃, SrCeO₃, BaCeO₃, CaZrO₃, e.g., doped with calcium oxide, yttrium oxide (yttria), lanthanum oxide, magnesium oxide, alumina oxide, and indium oxide, as well as combinations comprising at least one of the foregoing electrolyte materials, such as yttria doped zirconia, and the like.

The temperature sensing cell (74/26/76) can detect temperature of the sensing end 20 of the sensing element. The gas inlet 42 and 44 are to provide oxygen from the exhaust to the active layer 26 (e.g., an electrolyte layer) and avoid electrolyte 26 from being reduced electrically during the temperature measurement (electrolyte impedance method). The temperature sensor can be any shape and can comprise any temperature sensor capable of monitoring the temperature of the sensing end 20 of the sensor element 10, such as, for example, an impedance-measuring device or a metal-like resistance-measuring device. The metal-like resistance temperature sensor can comprise, for example, a line pattern (connected parallel lines, serpentine, and/or the like). Some possible materials include, but are not limited to, electrically conductive materials such as metals including platinum (Pt), copper (Cu), silver (Ag), palladium (Pd), gold (Au), and tungsten (W), as well as combinations comprising at least one of the foregoing.

A heater (not shown) can be employed to maintain the sensor element 10 at a selected operating temperature. The heater can be positioned as part of the monolithic design of the sensor element 10, for example between insulating layer 32 and insulating layer 34, in thermal communication with the temperature sensing cell 42/26/44 and the sensing cells 12/16/14, 18/16/14, and 12/16/18. In other embodiments, the heater could be in thermal communication with the cells without necessarily being part of a monolithic laminate structure with them, e.g., simply by being in close physical proximity to a cell. More particularly, the heater can be capable of maintaining the sensing end 20 of the sensor element 10 at a sufficient temperature to facilitate the various electrochemical reactions therein. The heater can be a resistance heater and can comprise a line pattern (connected parallel lines, serpentine, and/or the like). The heater can comprise, for example, platinum, aluminum, palladium, and combinations comprising at least one of the foregoing. Contact pads, for example the fourth contact pad 66 and the fifth contact pad 68, can transfer current to the heater from an external power source.

Disposed between the insulating layer 32 and another insulating layer (not shown) can be an electromagnetic shield (not shown). The electromagnetic shield isolates electrical influences by dispersing electrical interferences and creating a barrier between a high power source (such as the heater) and a low power source (such as the temperature sensor and the gas sensing cells). The shield can comprise, for example, a line pattern (connected parallel lines, serpentine, cross hatch pattern and/or the like). Some possible materials for the shield can include those materials discussed above in relation to the heater.

The first, second, and third electrical leads 50, 52, 54, are disposed in electrical communication with the first, second, and third contact pads 60, 62, 64, respectively, at the terminal end 80 of the sensor element 10. The fourth electrical lead 56 is disposed in electrical communication with the second contact pad 62. The fifth electrical lead 58 is disposed in electrical communication with the fourth contact pad 66. The fifth and sixth contact pads 68 and 70 can be used to supply electrical current from an external power source to cell components (e.g., the heater). The second, fourth, and fifth leads 52, 56, 58, are in electrical communication with the contacts pads through vias formed in the layers 22, 24, 28, 30, 32, 34 of the sensor element 10. Further, the first electrical lead 50 is disposed in physical contact and in electrical communication with the current collector 46 at a sensing end 20 of the sensor element 10. The second electrical lead 52 is disposed in physical contact and electrical communication with the reference electrode 14 at the sensing end 20. The third electrical lead 54 is disposed in physical contact and electrical communication with the NOₓ electrode 18 at the sensing end 20. The fourth electrical lead 56 is disposed in physical contact and in electrical communication with the electrode 74 and the fifth electrical lead 58 is disposed in physical contact and electrical communication with the electrode 76 of at the sensing end 20 of the sensor element 10. The lead 54 can be put under and protected by the layer 22. The lead 50 can be protected by putting an additional insulation layer on top of it.

The electrical leads 50, 52, 54, 56, 58, and the contact pads 60, 62, 64, 66, 68, 70 can be disposed in electrical communication with a processor (not shown). The electrical leads 50, 52, 54, 56, and the contact pads 60, 62, 64, 66, 68, 70, can comprise any material with relatively good electrical conducting properties under the operating conditions of the sensor element 10. Examples of these materials include gold (Au), platinum (Pt), palladium (Pd), Group VIII refractory metals such as iridium (Ir), osmium (Os), ruthenium (Ru), and rhodium (Rh), and combinations comprising at least one of the foregoing materials (e.g., gold platinum alloys (Au—Pt), gold palladium alloys (Au—Pd), and an unalloyed Group III refractory metal). Another example is material comprising aluminum and silicon, which can form a hermetic adherent coating that prevents oxidation.

The insulating layers 22, 24, 28, 30, 32, 34, can comprise a dielectric material such as alumina (i.e., aluminum oxide (Al₂O₃), and the like). Each of the insulating layers can comprise a sufficient thickness to attain the desired insulating and/or structural properties. For example, each insulating layer can have a thickness of up to about 200 micrometers or so, depending upon the number of layers employed, or, more specifically, a thickness of about 50 micrometers to about 200 micrometers. Further, the sensor element 10 can comprise additional insulating layers to isolate electrical devices, segregate gases, and/or to provide additional structural support.

The active layer 26 can comprise material that, while under the operating conditions of sensor element 10, is capable of permitting the electrochemical transfer of oxygen ions. These include the same or similar materials to those described as comprising electrolyte 16. Each active layer (including each electrolyte layer) can comprise a thickness of up to about 200 micrometers or so, depending upon the number of layers employed, or, more specifically, a thickness of about 50 micrometers to about 200 micrometers.

In an alternative arrangement, electrodes 12 and 18 can be put side by side (instead of 12 on top and 18 on bottom) or can be put 18 on top and 12 on the bottom.

The sensor element 10 can be formed using various ceramic-processing techniques. For example, milling processes (e.g., wet and dry milling processes including ball milling, attrition milling, vibration milling, jet milling, and the like) can be used to size ceramic powders into desired particle sizes and desired particle size distributions to obtain physical, chemical, and electrochemical properties. The ceramic powders can be mixed with plastic binders to form various shapes. For example, the structural components (e.g. insulating layers 22, 24, 28, 30, 32, and 34, the electrolyte 16 and the active layer 26) can be formed into “green” tapes by tape-casting, role-compacting, or similar processes. The non-structural components (e.g., the NH₃ electrode 12, the NOₓ electrode 18, and the reference electrode 14, the current collector 46, the electrical leads, and the contact pads) can be formed into tape or can be deposited onto the structural components by various ceramic-processing techniques (e.g., sputtering, painting, chemical vapor deposition, screen-printing, stenciling, and so forth).

In one embodiment, the ammonia electrode material is prepared and disposed onto the electrolyte (or the layer adjacent to the electrolyte). In this method, the primary material, e.g., in the form of an oxide, is combined with the dopant secondary material and optional other dopants, if any, simultaneously or sequentially. By either method, the materials are mixed to enable the desired incorporation of the dopant secondary material and any optional dopants into the primary material to produce the desired ammonia-selective material. For example, V₂O₅ is mixed with Bi₂O₃ and MgO by milling for about 2 to about 24 hours. The mixture is fired to about 800° C. to about 900° C. for a sufficient period of time to allow the metals to transfer into the vanadium oxide structure and produce the new formulation (e.g., BiMg_{0.05}V_{0.95}O₄₋ₓ (wherein x is the difference in the value between the stoichiometric amount of oxygen and the actual amount)), which is the reaction product of the primary material, secondary material and optional chemical stabilizing dopant, and/or diffusion impeding dopant. The period of time is dependent upon the specific temperature and the particular materials but can be about 1 hour or so. Once the ammonia-selective material has been prepared, it can be made into ink and disposed onto the desired sensor layer. The BiVO₄ is the primary NH₃ sensing material, and the dopant Mg is used to enhance its electrical conductivity.

The NOₓ electrode material can be prepared and disposed onto the electrolyte by similar methods. For example, Tb₄O₇ can be mixed with MgO and Cr₂O₃ with soft glass additives by milling for about 2 to about 24 hours. The mixture is fired to up to about 1,400° C. or so for a sufficient period of time to allow the metals to transfer into the oxide structure and produce the new formulation (e.g., TbCr_{0.8}Mg_{0.2}O_{2.9-x} (wherein x is the difference in the value between the stoichiometric amount of oxygen and the actual amount)), which is the reaction product of the primary material, secondary material and optional chemical stabilizing dopant, and/or diffusion impeding dopant.

The inlets 40, 42, 44 can be formed either by disposing fugitive material (material that will dissipate during the sintering process, e.g., graphite, carbon black, starch, nylon, polystyrene, latex, other insoluble organics, as well as compositions comprising one or more of the foregoing fugitive materials) or by disposing material that will leave sufficient open porosity in the fired ceramic body to allow gas diffusion therethrough. Once the “green” sensor is formed, the sensor can be sintered at a selected firing cycle to allow controlled burn-off of the binders and other organic material and to form the ceramic material with desired microstructural properties.

During use, the sensor element is disposed in a gas stream, e.g., an exhaust stream in fluid communication with engine exhaust. In addition to NH₃, O₂, and NOₓ, the sensor's operating environment can include, hydrocarbons, hydrogen, carbon monoxide, carbon dioxide, nitrogen, water, sulfur, sulfur-containing compounds, combustion radicals, such as hydrogen and hydroxyl ions, particulate matter, and the like. The temperature of the exhaust stream is dependent upon the type of engine and can be about 200° C. to about 550° C., or even about 700° C. to about 1,000° C.

The NH₃ sensing cell 12/16/14, the NOₓ sensing cell 18/16/14, and the NOₓ—NH₃ sensing cell 12/16/18 can generate emf as described by the Nernst Equation. In the exemplary embodiment, the sample gas is introduced to the NH₃ electrode 12, the reference electrode 14 and the NOₓ electrode 18 and is diffused throughout the porous electrode materials. In the electrodes 12 and 18, electro-catalytic materials induce electrochemical-catalytic reactions in the sample gas. These reactions include electrochemical-catalyzing NH₃ and oxide ions to form N₂ and H₂O, electrochemical-catalyzing NO₂ to form NO, N₂ and oxide ions, and electro-catalyzing NO and oxide ions to form NO₂. Similarly, in the reference electrode 14, electrochemical-catalytic material induces electrochemical reactions in the reference gas, primarily converting equilibrium oxygen gas (O₂) to oxide ions (O⁻²) or vice versa. The reactions at the electrodes 12, 14, 18 change the electrical potential at the interface between each of the electrodes 12, 14, 18 and the electrolyte 16, thereby producing an electromotive force. Therefore, the electrical potential difference between any two of the three electrodes 12, 14, 18 can be measured to determine an electromotive force.

The primary reactants at the electrodes of the NH₃ sensing cell 12/16/14 are NH₃, H₂O, and O₂. The partial pressure of reactive components at the electrodes of the NH₃ sensing cell 12/16/14 can be determined from the cell's electromotive force by using the non-equilibrium Nernst Equation (6):

$$emf \approx \frac{kT}{ae} Ln ( {P}_{{NH}_{3}} ) - \frac{kT}{be} Ln ( {P}_{{O}_{2}} ) - \frac{kT}{ce} Ln ( {P}_{{H}_{2} O} ) ) + constant \qquad ( 6 )$$

where: k=the Boltzmann constant
T=the absolute temperature of the gas
e=the electron charge unit
a, b, c, f, are constant
Ln=natural log
P_{NH}_{₃}=the partial pressure of ammonia in the gas,
P_{O}_{₂}=the partial pressure of oxygen in the gas,
P_{NO}_{₂}=the partial pressure of nitrogen dioxide in the gas
P_{H}_{₂}_{O}=the partial pressure of water vapor in the gas
P_{NO}=the partial pressure of nitrogen monoxide in the gas.

A temperature sensor can be used to measure a temperature indicative of the absolute gas temperature (T). The oxygen and water vapor content, e.g., partial pressures, in the unknown gas can be determined from the air-fuel ratio. Therefore, the processor can apply Equation (6) (or a suitable approximation thereof) to determine the amount of NH₃ in the presence of O₂ and H₂O, or the processor can access a lookup table from which the NH₃ partial pressure can be selected in accordance with the electromotive force output from the NH₃ sensing cell 12/16/14.

The air to fuel ratio can be obtained by ECM (engine control modulus, e.g., see GB2347219A) or by building an air to fuel ratio sensor in the sensor 10. Alternatively, a complete mapping of H₂O and O₂ concentrations under all engine running conditions (measured by instrument such as mass spectrometer) can be obtained empirically and stored in ECM in a virtual look-up table with which the sensor circuitry communicates. Once the oxygen and water vapor content information is known, the processor can use the information to more accurately determine the partial pressures of the sample gas components. Typically, the water and oxygen correction according to Equation (6) is a small number within the water and oxygen ranges of diesel engine exhaust. This is especially true when the water is in the range of 1.5 weight percent (wt %) to 10 wt % in the engine exhaust. This is because the water and oxygen have opposite sense of increasing or decreasing at any given air to fuel ratio and both effects cancel each other in Equation (6). Where there is no great demand for sensing accuracy (such as ±0.1 part per million by volume (ppm)), the water and oxygen correction in Equation 6 is unnecessary.

The emf output of the NH₃ cell can be interfered by NO₂ in the sample gas (see FIG. 8). For this reason we use a NOₓ cell to correct this interference effect.

The primary reactants at electrodes of the NOₓ sensing cell 18/16/14 are NO, H₂O, NO₂, and O₂. The partial pressure of reactive components at the electrodes of the NOₓ sensing cell 18/16/14 can be determined from the cell's electromotive force by using the non-equilibrium Nernst Equation, Equation (7):

$$emf \approx \frac{kT}{2 e} Ln ( {P}_{NO} ) - \frac{kT}{4 e} Ln ( {P}_{{O}_{2}} ) - \frac{kT}{2 e} Ln ( {P}_{{H}_{2} O} ) - \frac{kT}{2 e} Ln ( {P}_{{NO}_{2}} ) + constant \qquad ( 7 )$$

From Equation (7), at relatively low NO₂ partial pressures, the cell will produce a positive emf. At relatively high NO₂ partial pressures, the cell will produce a negative emf (with electrode 14 set at positive polarity).

The primary reactants at the electrodes of the NH₃—NOₓ sensing cell 12/16/14 are NH₃, NO, H₂O, NO₂, and O₂. The partial pressure of reactive components at these electrodes can be determined from the cell's electromotive force by using the non-equilibrium Nernst Equation that takes into account the effect of both Equation 7 and Equation 6.

At relatively high concentrations of NO₂, the NO₂ reacts at both the NH₃ electrode 12 and the NOₓ electrode 18. Therefore, the electrical potential at the NH₃ electrode 12 due to NO₂ reactions is approximately equal to the electrical potential at the NOₓ electrode 18 due to NO₂ reactions, resulting in zero overall change in electromotive force due to reactions involving NO₂. Therefore, in the NH₃—NOₓ sensing cell 18/16/12, when the NO₂ concentrations are relatively high, the amount of NH₃ becomes the only unknown in Equation (6). The processor can use emf output of cell 12/16/18 directly (or a suitable approximation thereof) to determine the amount of NH₃ in the presence of O₂ and H₂O, or the processor can access a lookup table from which the NH₃ partial pressure can be selected in accordance with the electromotive force output from the NH₃—NOₓ sensing cell 12/16/18 and from the air-fuel ratio information provided by the engine ECM. In most diesel exhaust conditions, the O₂ and H₂O effect will cancel each other such that there is no need to do air to fuel ratio correction of the emf output data.

Since at lower NO₂ partial pressures, the NH₃ sensing cell (12/22/14) more accurately detects NH₃, but at higher NO₂ partial pressures, the NH₃—NOₓ sensing cell (12/22/18) more accurately detects NH₃, the processor selects the appropriate cell according to the selection rule below:

1. Whenever the electromotive force between the NOₓ electrode 18 and the reference electrode 14 (measured at positive polarity) is greater than a selected emf (e.g., 0 millivolts (mV), +10 mV, or −10 mV), the NH₃ electromotive force is equal to the electromotive force measured between the NH₃ electrode 12 and the reference electrode 14. The selected emf is typically determined from the emf of cell 18/16/14 in the presence of zero NH₃ and NOₓ.

2. Whenever the electromotive force between the NOₓ electrode 18 and the reference electrode 14 is not greater than the selected emf (e.g., 0 millivolts (mV), +10 mV, or −10 mV), the NH₃ electromotive force is equal to the electromotive force between the NH₃ electrode 12 and the NOₓ electrode 18.

Referring to FIG. 8, a graphical representation 100 is shown. The tested sensor had a BiVO₄ (5% MgO) NH₃ electrode, a TbMg_{0.2}Cr_{0.8}O₃NOₓ electrode, and a Pt reference electrode. The sensor was operated at 560° C. The graphical representation includes a line representing the voltage (line 102) across the NH₃ sensing cell, a line representing the voltage (line 104) across the NOₓ sensing cell, and a line 106 representing the voltage across the NH₃—NOₓ cell. The graphical representation 100 further includes four sections representing NO₂ and NO concentrations: a first section 108 where NO and NO₂ concentrations are 0 ppm (parts per million), a second section 110 where NO concentration is 400 ppm and NO₂ concentration is 0 ppm, a third section 112 where NO concentration is 200 ppm and NO₂ concentration is 200 ppm, and a fourth 114 section where NO concentration is 0 ppm and NO₂ concentration is 400 ppm. Each of the sections 108, 110, 112, 114, include seven subsections representing NH₃ concentrations: a first subsection 116 where the NH₃ concentration is 100 ppm, a second subsection 118 where the NH₃ concentration is 50 ppm, a third subsection 120 where the NH₃ concentration is 25 ppm, a fourth subsection 122 where the NH₃ concentration is 10 ppm, a fifth subsection 124 where the NH₃ concentration is 5 ppm, a sixth subjection 126 where the NH₃ concentration is 2.5 ppm, and a seventh subjection 128 where the NH₃ concentration is 0 ppm. The remaining gas is composed of 10% O₂, 1.5% of H₂O and balanced by N₂. As shown in FIG. 8, although the line 102 is identical in section 108 and 110, it has a lower value in section 112 and 114 where NO₂ is present.

In an exemplary embodiment, the emf of NOₓ cell at 0 NOₓ is 0 mV (see line 104 at section 128), therefore the selected emf is a voltage of zero. When NO₂ concentration is 0 ppm as in section 108 and section 110, the voltage (line 104) measured by the sensor across the NOₓ sensing cell would be greater than 0. Therefore, the sensor would use the voltage (line 102) across the NH₃ sensing cell to determine the NH₃ concentration in the sample gas. When NO₂ concentration is 200 as in section 112 or 400 ppm as in section 114, the voltage (line 104) across the NOₓ sensing cell will not be greater than 0. Therefore, the sensor would use the voltage 106 across the third sensing cell (the NH₃ —NOₓ sensing cell) to determine the NH₃ concentration in the sample gas. As can be seen, the line 102 in sections 108 and 110 are almost identical to the line 106 in section 112 and 114, meaning that the NH₃ concentration can be determined without the interference of NO₂.

The sensing element and method disclosed herein enable a more accurate NH₃ determination than was possible when the effects of NOₓ were not factored into the reading. This sensing element is capable of detecting ammonia at a concentration of 1 ppm without the interference of NOₓ. The devices have wide temperature ranges of operation (from 400° C. to 700° C.) and are independent of the flow rate of the exhaust. The self-compensation of the water and oxygen interference works for exhaust gas that has a water concentration equal or larger than 1.5%. Below this number, water and oxygen effect correction can be implemented by using Eq. 6, by using the look up table and the air to fuel ratio information provided by the ECM, or by an air fuel ratio sensor that can be a separate sensor or combined with this sensor.

It should be noted that the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced items. As used herein, “combination” is inclusive of blends, mixtures, alloys, reaction products, and the like, as appropriate. The modifier “about” used in connection with a quantity is inclusive of the stated value and has the meaning dictated by the context (e.g., includes the degree of error associated with measurement of the particular quantity). Furthermore, all ranges disclosed herein are inclusive and combinable (e.g., ranges of “up to about 25 weight percent (wt. %), with about 5 wt. % to about 20 wt. % desired, and about 10 wt. % to about 15 wt. % more desired,” are inclusive of the endpoints and all intermediate values of the ranges, e.g., “about 5 wt. % to about 25 wt. %, about 5 wt. % to about 15 wt. %”, etc.). Finally, unless defined otherwise, technical and scientific terms used herein have the same meaning as is commonly understood by one of skill in the art to which this invention belongs. The suffix “(s)” as used herein is intended to include both the singular and the plural of the term that it modifies, thereby including one or more of that term (e.g., the metal(s) includes one or more metals). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method of operating a gas measurement system having a sensor element outputting a first signal originating from an ammonia sensing electrode having a sensitivity to heavy hydrocarbons (HC) and a second signal originating from a NOₓ sensing electrode, said method comprising the step of suppressing a third signal indicative of ammonia concentration in the gas when a difference between the second signal and the first signal is greater than or equal to a first threshold.

2. The method of claim 1 further comprising the step of:
determining a heavy HC concentration when the second signal exceeds the first signal by the first threshold.

3. The method of claim 2 wherein said step of determining the heavy HC concentration includes the sub-step of:
scaling the first signal by a first predetermined constant.

4. The method of claim 2 wherein said step of determining the heavy HC concentration includes the sub-step of:
evaluating a first relationship as a function of the first signal.

5. The method of claim 4 wherein said first relationship is defined by:
heavy HC concentration (ppm)=G+H*EXP(J*EMF1)
where EMF1 is the first signal and G, H and J are first, second and third predetermined constants.

6. The method of claim 1 wherein said suppressing step includes the sub-step of assigning a zero value to the third signal indicative of said ammonia concentration.

7. The method of claim 1 further comprising the step of valuing the third signal indicative of ammonia concentration in the gas when the difference between the second signal and the first signal is less than the first threshold.

8. The method of claim 7 wherein said valuing step includes the sub-step of:
assigning the value of the first signal to the third signal when the second signal is equal to or greater than a second threshold.

9. The method of claim 7 wherein said valuing step includes the sub-step of:
subtracting the second signal from the first signal to form a second difference;
assigning the value of the second difference to the third signal when the second signal is less than a second threshold.

10. A gas measurement system comprising:
a sensor including an ammonia sensing electrode having an electrochemical sensitivity to ammonia and to heavy hydrocarbons (HC) configured to output a first signal, and a NOₓ sensing electrode having a sensitivity to at least NO₂ configured to output a second signal; and
an electronic controller configured to generate a third signal indicative of an ammonia concentration in the gas, said controller being further configured to suppress said third signal when a difference between said second signal and said first signal is greater than or equal to a first threshold.
